(19) United States
(12) Patent Application Publication
(10) Pub. No.: US 2010/0002079 A1
(43) Pub. Date: Jan. 7, 2010

(54) MULTI-VIEW DISPLAY DEVICES

(75) Inventors: Marcellinus Petrus Carolus Michael Krijn, Eindhoven (NL); Oscar Hendrikus Willemsen, Eindhoven (NL); Remco Theodorus Johannes Muijs, Eindhoven (NL); Petrus Johannes Hendrikus Seuntiens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,020

(22) PCT Filed: Jun. 14, 2007
(86) PCT No.: PCT/IB07/52260

§ 371 Date: Jun. 10, 2009

(30) Foreign Application Priority Data
Jun. 16, 2006 (EP) 06115599.0

(51) Int. Cl. H04N 7/18; G09G 5/00; H04N 5/335

(52) U.S. Cl. 348/148; 345/9; 348/308; 348/E05.091; 348/E07.085

(57) ABSTRACT

A display system, comprises a multi-view display panel (10) adapted to display different images to different viewers in different directions. Imaging means (16) monitors viewers within a field of view and the display output is varied in dependence on the monitoring information provided by the imaging means. The invention thus provides a display display system which captures viewer information and uses this to control the display of multiple images at appropriate respective viewing angles. This enables information to be tailored to a particular viewer's characteristics or enables a user to be tracked as they move. Thus, different viewers can have personalised information when watching different views of the same display. This provides a dynamic view allocation system.

### FIELD OF THE INVENTION

The present invention relates to a display system, comprising: a multi-view display panel adapted to display different images to different viewers in different directions.

### BACKGROUND OF THE INVENTION

There currently exist numerous devices which provide different viewing angles for different images, allowing more than one viewer to see different information from one screen.

Typically, known devices provide a number of images by means of an optical arrangement which manipulates the directions to which different images are displayed, such as lenticular lens arrays to control the viewing angle. Other types of multiple display include split screen information on a single screen, or the use of multiple screens, but this invention relates to displays in which a single panel is used to display different information to multiple viewers at the same time.

An example of the known use of a two-view display is in car entertainment and satellite navigation systems for vehicles. These devices provide different information for the viewer and passenger, and each viewer can select the information they wish to view. The position of each viewer is fixed allowing the correct viewing angle to be defined easily, for example by a lens device which overlies the display.

Another known device provides a single user with two views so that a 3D image is generated, and optical head tracking is used to direct the views in appropriate directions. The screen output is changed mechanically or electro-optically taking account of the viewers left and right eye positions, to generate a stereo pair of images. The two views are always generated towards the single viewer.

The known uses of multi-view displays thus comprise 3D displays for a user (who must normally be at a particular distance from the screen) or for multiple users in known positions. In each case, the view allocation is static.

The invention is based on the recognition that the range of applications of a multi-view display device can be extended.

### SUMMARY OF THE INVENTION

The invention is defined by the independent claims. The dependent claims define advantageous embodiments.

The invention thus provides a display system which captures viewer information and uses this to control the display of multiple images at appropriate respective viewing angles. This enables information to be tailored to a particular viewer's characteristics or enables a user to be tracked as he moves. Thus, different viewers can have personalised information when watching different views of the same display. This provides a dynamic view allocation system.

The display system can simultaneously show single viewers or groups of people different images. The system can monitor the viewer when stationary or can track a user in motion passing within the field of view of the imaging means.

Depending on the information captured, the system will display an image at an angle for the particular user so that the image can be viewed. A viewer in motion can continue to be tracked so that as the viewer moves past the display, the viewing angle will vary to enable the viewer to see the image continuously.

The image capturing device may be a camera which is adapted to capture and track an image of a viewer. Other methods of tracking are also possible, including the use of Radar and Lidar systems. In the simplest examples, there is no need for any viewer interaction with the system other than being captured by the image capturing device.

The information captured by the camera can categorise the viewers to determine the image to be displayed. The types of category may include, but not be limited to: height; hair colour, eye colour, gender, age and colour of clothes.

In another arrangement of the invention, the camera is for capturing traffic information (whether stationary or in motion). This information can be used to provide vehicle specific warnings, advertisements or advice on the display.

The camera may identify vehicle categories in order to determine the information to be displayed, such as: traffic speed; vehicle type; vehicle style; vehicle colour; vehicle speed and vehicle identification information.

The invention also provides a method of controlling a display system, the system comprising a multi-view display panel, the method comprising:

monitoring viewers within a field of view of the display panel;

controlling the display output in dependence on the monitoring information provided by the imaging means, thereby to display different images to different viewers in different directions.

This provides a dynamic view allocation method for a multiple view display.

### BRIEF DESCRIPTION OF THE DRAWINGS

The present invention will now be described solely by way of example and with reference to the accompanying drawings wherein:

FIG. 1 is a schematic plan view of a known autostereoscopic display device;

FIG. 2 is a schematic plan view of the first embodiment according to the invention;

FIG. 3 is a schematic plan view of the second embodiment according to the invention;

FIG. 4 is a schematic perspective view of the display system shown in FIG. 3;

FIG. 5 is a schematic plan view of the third embodiment according to the invention.

### DETAILED DESCRIPTION OF EMBODIMENTS

The invention provides an display device in which multiple views can be displayed to different viewers, and the display output to the different views is controlled based on an image captured of the field of view of the display. The display device may use the technology of known autostereoscopic displays.

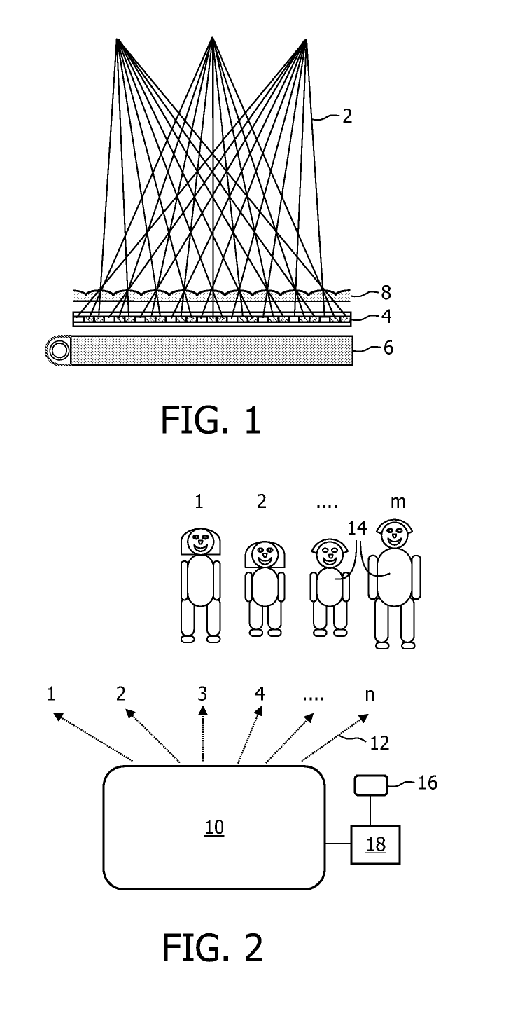

FIG. 1 is a schematic plan view of the use of a known direct view autostereoscopic display. The known device 2 comprises a liquid crystal display panel 4 and a backlight 6.

The display panel 4 has an orthogonal array of display pixels arranged in rows and columns. For the sake of clarity, only a small number of display pixels are shown in FIG. 1. In practice, the display panel 4 might comprise of about one thousand rows and several thousand columns of display pixels.

The structure of the liquid crystal display panel 4 is entirely conventional. In particular, the panel 4 comprises of a pair of spaced transparent glass substrates between which an aligned twisted nematic or other liquid crystal material is provided. The substrates carry patterns of transparent indium tin oxide (ITO) electrodes on their facing surfaces. Polarising layers are also provided on the outer surfaces of the substrates.

Each display pixel comprises opposing electrodes on the substrates with the intervening liquid crystal material therebetween. The shape and layout of the display pixels are determined by the space and layout of the electrodes. The display pixels are regularly spaced from one another by gaps.

Each display pixel is associated with a switching element, such as a thin film transistor (TFT) or a thin film diode (TFD). The display pixels are operated to produce the display by providing addressing signals to the switching elements, and suitable addressing schemes will be known to those skilled in the art.

The gaps between the display pixels are covered by an opaque black mask. The mask is provided in the form of a grid of light absorbing material. The mask covers the switching elements and defines the individual display pixel areas.

The display panel 4 is illuminated by a light source 6 comprising, in this example, a planar backlight extending over the area of the display pixel array. Light from the light source 6 is directed through the display panel 4, with the individual display pixels being driven to modulate the light and produce the display.

The display device 2 also comprises a lenticular sheet 8 arranged over the display side of the display panel 4. The lenticular sheet 8 comprises a row of lenticular elements extending parallel to one another, in the column direction (or slightly offset from the column direction).

FIG. 2 shows a first example of the system of the invention, using a display device of the type explained with reference to FIG. 1. The device of FIG. 1 can be considered as a multiple view 2D display, rather than a 3D display, and all different views can be derived independently, rather than in stereo pairs as in the conventional use of the display.

FIG. 2 shows a multi-view display 10 generating n views 12, preferably non-overlapping. In front of the display, there are m viewers 14 watching the display; preferably, n>m.

A camera 16 is provided for monitoring the viewers within the field of view of the display, and this provides information to a controller 18 which is used to drive the display 10.

The purpose of the camera is two-fold:

(i) It is used as part of a multi-viewer head-tracker in order to determine the position of each individual viewer or group of viewers relative to the views generated by the display.

(ii) It is used to determine one or more characteristics of each viewer or group of viewers watching the display.

The infotainment (information and/or entertainment) displayed in each view of the multi-view display is selected depending on both types of information gathered by the camera (i.e. the location of the viewers as well as characteristics of the viewers).

Some examples of how the infotainment displayed in each view can be made to depend on the two types of information acquired by the camera will now be described.

With reference to FIG. 2, several viewers are watching the same multi-view display. The camera determines their position and characteristics such as for example height (to discriminate between young and adult people), hair colour, glasses, colour of their clothes, etc.

The arrangement of FIG. 2 can be used for example for advertisement purposes. In one example, the display and camera can be located in a shop window. People passing the display will be offered private advertisements tailored to their ‘needs’. People that match according to some criteria are notified. This may be used for directed advertising, for example including dating information.

The arrangement can also be used for video-on-demand. Children can be offered a choice from a selection of educational programs or cartoons whereas adults choose from a broader range of programs that are visible only from their location. This can be combined with directional sound.

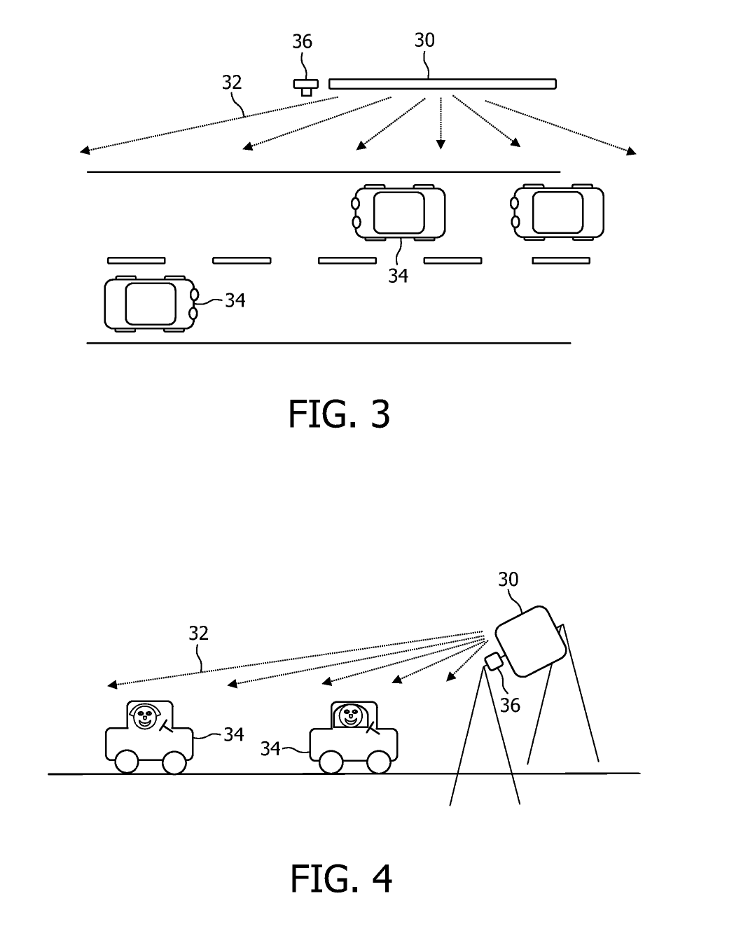

FIG. 3 shows a second example of device of the invention in which the display is a road side display for providing information to drivers, and which is able to provide different information to different drivers at the same time. The multiple view display 30 displays a number of images 32. Each image is directed at a viewing angle according to a vehicle position. Three vehicles 34 are shown.

The camera 36 in the embodiment in FIG. 3 has a field of view sufficient to capture an image of the passing traffic. The camera 36 is of a suitable quality to capture an image of the vehicles, and tolerate different vehicle speeds as well as distances from the camera. The camera has the ability to track the position and speed of a car as it passes the multiple view display 30 allowing the correct viewing angle to be controlled.

The images are processed to display an appropriate image 32 at the correct angle on the multiple view display 30.

The images captured by the camera 36 in the embodiment in FIG. 3 can be analysed to obtain information concerning general traffic speed, vehicle type, vehicle style, vehicle colour, specific vehicle speed, distance from vehicle to the vehicle in front, or vehicle identification information.

Drivers that do not comply with legal requirements could then have warning or advisory information generated and displayed to them in a view orientated towards their vehicle. The arrangement can thus be used to prevent speeding and enforce drivers to keep a certain distance to the car in front.

FIG. 4 shows the system of FIG. 3 in side view.

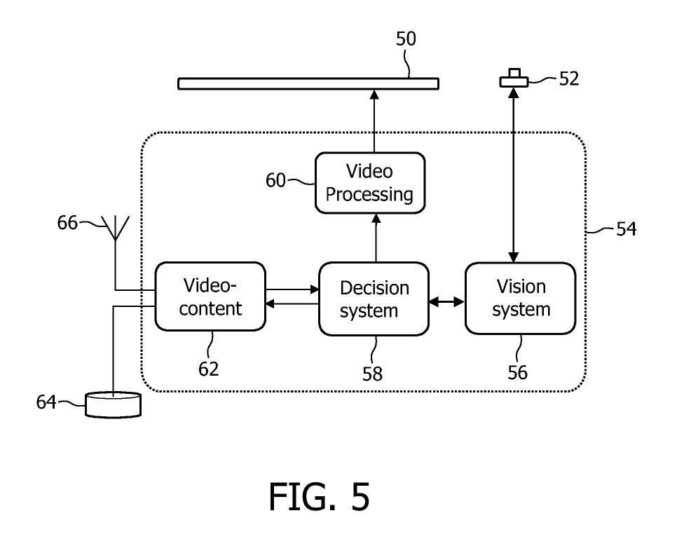

FIG. 5 shows in more detail the system used to process the obtained image information and control the display output.

The system comprises the display 50, camera 52 and control unit 54. The control unit 54 has an image acquisition unit 56 which derives the required information from image, typically combining location information and data characterising the users (or vehicles) within the field of view.

A decision unit 58 processes the image content and uses the information to control the display 50 using a video processing unit 60. The decision unit 58 may also obtain video content from unit 62 which obtains video from a database 64 or live using an antenna 66.

The camera may also be controlled by the vision system so that it can pan across the field of view under the control of the decision unit 58.

Specific examples of the invention have been described. However it will be possible and apparent to those skilled in the art that various changes and modification may be made to these embodiments without varying the scope of the invention.

For example the imaging means in the above examples is described as being a camera, and this may be a CMOS device or a charge coupled device. However it will be apparent to those skilled in the art that there are other ways of tracking a viewer or traffic using a detecting and ranging device (RADAR) or light detection and ranging device (LIDAR).

The specific embodiments above describe a multiple view display using an LCD panel with a lenticular mask to generate multiple images to multiple locations. However, it will be apparent to those skilled in the art that other types of display may be used such as cathode ray tube (CRT) or a plasma display. Other methods of varying the display viewing angle may also be employed, for example using a mask or barrier with a periodic slit arrangement.

Although the embodiments describe some of the possible information that may be displayed on the multiple view display, it will be apparent to those skilled it the art that the examples provided are not an exhaustive list of all the media that may be presented.

The invention thus extends the uses of a multi-view display beyond the typical 3D applications, and recognises that the information to be displayed to different viewers, each at their own viewing angle, can be controlled based on perceived viewer needs or desires. As will be clear from the above, this can have applications in direct advertising, personalised warning systems and multiple viewer on-demand viewing applications.

This extends the known use of multiple view displays in which the information to different views are predetermined and fixed, by making the content of the views adapt in response to features observed in the field of view. The view allocation is thus dynamic rather than static.

Imaging software for identifying features and tracking these features within a field of view is readily available. The way in which such feature information can be used to select views to be displayed will be routine to those skilled in the art, and will typically involve the selection of one of a number of previously selected display options. For example, a database of video clips may be provided, with different video clips for people with specific features. The display output may also be adapted in a more personalised manner, for example to display a user's registration plate as part of a speeding or other warning.

Various other modifications will be apparent to those skilled in the art.

1. A display system, comprising:
a multi-view display panel (10) adapted to display different images to different viewers (1 . . . m) in different directions within a field of view of the multi-view display panel;
imaging means (16) for monitoring viewers within the field of view; and
control means (18) for controlling the display output in dependence on the monitoring information provided by the imaging means, wherein the imaging means identifies characteristics of at least one person within the field of view.

2. A display system according to claim 1, wherein the imaging means (16) is adapted to track at least one of the different viewers (1 . . . m) in motion to determine the position of the at least one of the different viewers in relation to the multi-view display panel.

3. A display system according to claim 1, wherein the imaging means (16) comprises a charged coupled device or CMOS camera.

4. (canceled)

5. A display system as claimed in claim 1, wherein the imaging means (16) is adapted to capture information concerning the height, hair colour, gender or colour of clothes of the at least one person.

6. A display system as claimed in claim 1, wherein the imaging means (16) is for monitoring the vehicles of viewers, and is adapted to identify characteristics of one or more vehicles (34) within the field of view.

7. A display system as claimed in claim 6, wherein the imaging means is adapted to capture information comprising vehicle type, vehicle colour, vehicle speed or vehicle identification information.

8. A display system as claimed in claim 1, wherein the multi-view display panel (10) comprises a display having a lenticular screen (8) for directing the different images to the different viewers in the different directions.

9. A method of controlling a display system according to claim 1, the method comprising:
monitoring viewers within a field of view of the display panel (10) to obtain monitoring information;
identifying characteristics of at least one person within the field of view based on the monitoring information; and
controlling the display output in dependence on the monitoring information provided by the imaging means, thereby to display different images (1 . . . n) to different viewers (1 . . . m) in different directions.

10. The method as claimed in claim 9, wherein monitoring viewers comprises obtaining location information concerning the viewers and viewer characteristic information.

11. The method as claimed in claim 9, wherein monitoring viewers comprises obtaining location information concerning the vehicles (34) in which the viewers are located and viewer vehicle characteristic information.
